(19) United States
(12) Patent Application Publication
(10) Pub. No.: US 2007/0093931 A1
(43) Pub. Date: Apr. 26, 2007

(54) Resin molding metal mold and resin molding method for flat display panel cabinet, and plasma display televison

(75) Inventor: Naoto Maruta, Osaka (JP)

Correspondence Address: Yokoi & Co.;U.S.A., Inc., 13700 Marina Pointe Drive #723, Marina Del Rey, CA, 90292, US

(73) Assignee: Funai Electric Co. Ltd., Osaka (JP)

(21) Appl. No.: 11/583,191

(22) Filed: Oct. 19, 2006

(30) Foreign Application Priority Data
Oct. 24, 2005 (JP) JP2005-308479

(51) Int. Cl. B29C 39/00

(52) U.S. Cl. 700/197

(57) ABSTRACT

Conventionally, different metal molds are necessary to mold different-sized flat display panel cabinets. A common cabinet is used for different-sized flat display panels. Also, a core metal mold is shaped to have a concave side surface that forms a resin molding cavity accommodating all the sizes of the cabinet for flat display panel. By doing this, a common metal mold can be used for different-sized flat display panels.

### CROSS-REFERENCES TO RELATED APPLICATIONS

The present application is related to the Japanese Patent Application No. 2005-308479, filed Oct. 24, 2005, the entire disclosure of which is expressly incorporated by reference herein.

### BACKGROUND OF THE INVENTION

(1) Field of the Invention

The present invention relates to a resin molding metal mold and resin molding method for molding a cabinet to be mounted at the view area of a flat display panel, and a plasma display television provided with the cabinet.

(2) Description of the Related Art

Televisions that display broadcast pictures to be watched by audiences have been widely used at home for a long time as major media for watching entertainment programs, movies, news, etc. However, Cathode Ray Tube (CRT)-based televisions which have been the mainstream for a long time have problems with depth, weight, and/or power consumption, and therefore increasing their screen sizes was about to reach a limit.

Meanwhile, with the improvement in semiconductor technologies, new display devices such as plasma displays and Liquid Crystal Displays (LCDs) have been developed in recent years that are different from CRTs. Since these display devices are thinner as compared with conventional CRTs, they are often generically called flat display panels.

The flat display panels for televisions have achieved reduced cost and increased size due to technological improvements and volume efficiency, and, coupled with replacement demand associated with the digitalization of television broadcast as well as housing conditions in Japan with restricted spaces, the market for flat display panels is rapidly expanding, taking over the conventional CRTs.

When manufacturing televisions using these flat display panels, some manufacturers fabricate such televisions by using panel assemblies acquired from a panel manufacturer and adding their own control processing technology and the like to the panel assemblies. These general-purpose panel assemblies have various-sized view areas, and TV manufactures typically fabricate televisions by using different components according to different-sized panel assemblies.

However, for different panel assemblies with approximate view areas sizes, for example, the same cabinets are often used as common cabinets to which these panel assemblies are mounted, for cost reduction. FIG. 10 shows a partial cross-sectional views of 26-inch and 27-inch plasma display panel assemblies 1a and 1b which are mounted to a common cabinet 2 as flat display panels.

In FIG. 10, the cabinets 2 to which the 26-inch and 27-inch plasma display panel assemblies 1a and 1b are mounted are the same. However, since view area sizes of the panel assemblies 1a and 1b are different, the distance between the panel-side peripheral edges of the cabinet and the circumference of the view area of the panel assembly 1a is naturally different from that of 1b. Therefore, it is impossible to directly cover up to the circumference of the view area of each of the panel assemblies 1a and 1b with the panel-side peripheral edge of the common cabinet 2. Accordingly, a double structure configuration is employed wherein the panel-side peripheral edge of the common cabinet 2 is held in front of the circumference of the view area of the panel assemble 1a, 1b to provide a gap, and thereby accommodate the difference in gaps formed by different panel sizes, and then the gap is covered with a decorative laminate 3a, 3b called a bezel as shown in FIG. 11 that fits the size of each panel assembly.

To mold the bezels 3a, 3b with resin, a pair of metal molds comprising a core metal mold and a cavity metal mold are needed. That is, as shown in a partial cross-sectional view of FIG. 12, an approximately rectangular molding groove 4a is formed on the core metal mold 4 at a position corresponding to the circumference of the view area of the plasma display panel 1a, 1b. The molding groove 4a is formed on an area with approximately trapezoidal cross-section composed of: a bottom 4b corresponding to an area opposite to the screen of the plasma display panels 1a, 1b; an approximately vertical surface 4c corresponding to the inward of the view area; and a tapered surface 4d corresponding to the outward of the view area. On the other hand, the cavity metal mold 5 has a convex portion 5a with approximately trapezoidal cross-section that is composed of: a bottom 5b of having the same shape as an approximately rectangular area surrounded by the molding groove 4a of the core metal mold; and an upwardly expanding tapered surface 5c formed around the bottom 5b.

To form the bezel 3a, 3b, the approximately rectangular area surrounded by the molding groove 4a on the core metal mold 4 and the bottom 5b of the convex portion 5a of the cavity metal mold 5 are brought into contact with each other, and resin is injected into a cavity 6 formed by the molding groove 4a on the core metal mold 4, the outward surface 4f of the molding groove 4a, and the convex portion 5a, tapered surface 5c, and outward surface 5d of the cavity metal mold 5.

As described above, since the distance to the gap to be covered by the bezel is different between the 26-inch and 27-inch plasma display panel assemblies 1a, 1b, bezels of different length must to molded according the difference in the distance. This necessitates changing the position of the molding groove on the core metal mold 4, and the position of the convex portion 5a of the cavity metal mold 5. As a result, it is necessary to prepare four types of metal molds 4 and 5, two types for each of the 26-inch and 27-inch plasma display panel assemblies. This results in the following problems:

That is, many types of metal mold are required and the cost increases substantially.

Also, since metal molds for molding the bezels are used for large-sized plasma display panels such as 26-inch and 27-inch panels, and sizes of those metal molds are very large, a very large storage space is necessary to prepare metal molds for different-sized plasma display panel assemblies.

Furthermore, it is also necessary to replace metal molds according to panel assembly sizes, and this mold change work consumes a great deal of time.

On the other hand, for reducing the number or cost of metal molds used for resin molding, the following technology is disclosed.

That is, according to Japanese Patent Laid-Open No. 2001-298831 (Patent Document 1), in molding an electrical junction box, the junction box is divided into a cavity portion and a box body, and the cavity portion is first molded and then the molded cavity portion is inserted into the box body. By doing this, when the cavity portion alone or the box body alone is different, the other metal mold can be used in common, and therefore it is possible to reduce the cost and number of metal molds as compared with a case where the cavity portion and box body are integrally molded.

According to Japanese Utility Patent Laid-Open No. 1993-16256 (Patent Document 2), in a cavity metal mold and a core metal mold each having a fitting nest, a blocking lever is attached to the nest of the core metal mold that can be moved in and out of a molding concave portion. The blocking lever is moved in to block the injection of resin according to the molding shape. This eliminates the need for replacing the nest for molding and as a result the cost and number of metal molds can be reduced.

According to Japanese Patent Laid-Open No. 1993-278081 (Patent Document 3), different shape molding is enabled by providing a removable nest portion in some part of a metal mold and replacing only the next portion. This allows only a nest portion to be replaced without having to prepare a whole metal mold, and consequently the cost and number of metal molds can be reduced.

Also, the following prior art is disclosed that enables a plastic television cabinet to be molded without a weld line or gate trace.

That is, according to Japanese Patent Laid-Open No. 1996-132481 (Patent Document 4), resin is injected before finishing the clamping, and the gap between cavity and core molds is filled with the resin injected through a film-like gate without providing a runner. The gate is cut by the clamping before the resin is hardened at a convex portion provided on the border between product and gate. By doing the above, a runner becomes unnecessary and no weld line or gate trace is left, thus improving the appearance quality.

However, in the configuration of the above-mentioned Japanese Patent Laid-Open No. 2001-298831 described above, although the cost and number of metal molds can certainly reduced as compared with a case where the cavity portion and box body are integrally molded, it is still necessary to prepare different metal molds for portions requiring different molding in separately molded cavity portion and box body.

When mounting different-sized plasma display panels to the cabinet as described above, the double structure composed of a cabinet and a bezel and the common use of a cabinet are already proposed. The problem is that many different metal molds are required in order to mold different-sized bezels. Therefore, this problem cannot be solved by the technology disclosed in the above-mentioned Patent Document 1.

In the configuration of Patent Document 2, it is certainly possible to reduce the number of metal molds by providing a shielding lever and moving the same in and out of the molding concave portion. However, if this configuration is applied to the molding of the cabinet or bezel, a parting line corresponding to a mounting seam of the nest is inevitably formed. Since the cabinet and bezel is positioned at the outside of a product and meets the eyes of consumers, this parting line damages the appearance quality and therefore it is difficult to apply this configuration.

When applying the configuration in the above-mentioned Japanese Patent Laid-Open No. 1993-278081, if the portion molded by a replaceable nest is limited to part of the cabinet or bezel, a parting line corresponding to the mounting seam of the nest is inevitably formed just like the above configuration, thus damaging the appearance and making it difficult to apply. In contrast, if the portion molded by the replaceable nest is expanded to the entire cabinet or bezel, the parting line problem is eliminated, but this is not much different from replacing a metal mold entirely and the problem still cannot be solved.

The configuration of the above-mentioned Japanese Patent 1996-132481 is a technology to prevent a weld line and a gate trace from being formed, and therefore is unable to solve the problem of increased number of metal molds described above.

### BRIEF SUMMARY OF THE INVENTION

The present invention discloses resin molding metal molds and a resin molding method for flat display panel cabinets that resolves the problems with resin molding metal molds used for molding a cabinet to be mounted to the view area of different sized flat display panels, specifically the problem of double structure formed by a cabinet and a bezel and the problem of requiring various types of metal mold to mold different-sized bezels. Further, the present invention uses a common core metal mold for different sized cabinets and thereby reduce the number of metal molds. In addition, the present invention eliminates the need for the double structure wherein a cabinet and a bezel are mounted.

One aspect of present invention provides a plasma display television whose cabinet molded by resin molding metal molds is mounted to the view area of a plasma display panel as a flat display panel, wherein: the plasma display panel is a general-purpose plasma display panel of one of a first size or a second size that is slightly larger than the first size; the metal molds include a core metal mold and cavity metal mold used in pairs; the core metal mold has two different molding grooves: an approximately rectangular first molding groove located at a position corresponding to a first view area circumference of the plasma display panel of the first size, and an approximately rectangular second molding groove that is one size larger than the first view area circumference and located at a position corresponding to a second view area circumference of the plasma display panel of the second size; the first molding groove and the second molding groove are formed on an area with approximately trapezoidal cross-section composed of a bottom surface corresponding to a position opposite to the screen of a plasma display panel, an approximately vertical surface corresponding to an inward side of the view area, and an expanding tapered surface corresponding to an outward side of the view area; the cavity metal mold has two different cavity metal molds including a first cavity metal mold corresponding to a first size of the plasma display panel, and a second cavity metal mold corresponding to a second size of the plasma display panel; the fist cavity metal mold has a convex portion with approximately trapezoidal cross-section which is made up of an undersurface having the same shape as an approximate rectangle surrounded by the first molding groove on the core metal mold, and an upwardly expanding tapered surface formed around the undersurface; the second cavity metal mold has a convex portion with approximately trapezoidal cross-section which is made up of an undersurface having the same shape as an approximate rectangle surrounded by the second molding groove on the core metal mold, and an upwardly expanding tapered surface formed around the undersurface; a cabinet for a plasma display panel of the first size is molded by making an approximately rectangular surface surrounded by the first molding groove on the core metal mold and an undersurface of the convex portion on the first cavity metal mold relatively contact each other, and injecting resin into a cavity formed by the first molding groove and the second molding groove on the core metal mold, a surface between these two molding grooves, an outward surface of the second molding groove, a tapered surface of the convex portion on the first cavity metal mold, and an outward upper surface thereof; a cabinet for the plasma display panel of the second size is molded by contacting an approximately rectangular surface surrounded by the second molding groove on the core metal mold and an undersurface of the convex portion on the second cavity metal mold, covering the first molding groove by an undersurface of the convex portion, and injecting resin into a cavity formed by the second molding groove on the core metal mold and a surface outward thereof, and a tapered surface of the convex portion of the second cavity metal mold and an upward upper surface thereof; one of the two cavity metal molds is combined with a common core metal mold as appropriate, and cabinets for two general-purpose plasma display panels of the first and seconds sizes respectively are individually molded; the number of metal mold can be reduced by using a common core metal mold for general-purpose plasma display panels of the first and second sizes; and the need for the double structure is eliminated that is required to cover the gap between the view area of the plasma display panel and the cabinet when mounting a general-purpose plasma display of the first size or the second sizes to a common cabinet.

In this aspect as described above, a cabinet for a plasma display panel of the first size is molded by using a combination of the core metal mold and the first cavity metal mold and injecting resin into a cavity formed by the first and second molding grooves on the core metal, a surface between these molding grooves, a surface outward of the second molding groove, while the tapered surface and outward upper surface of the convex portion on the first cavity metal mold, and a cabinet for a plasma display panel of the second size is molded by injecting resin into a cavity formed by the second molding groove on the core metal mold and an outward surface thereof and the tapered surface and an outward upper surface of the convex portion of the second cavity meta mold, with the first molding groove being covered by the bottom surface of the convex portion.

Accordingly, the number of metal molds can be reduced by using a common core metal mold for plasma display panels of the first and second sizes, and also the double structure becomes unnecessary that is required when mounting a common cabinet to general-purpose plasma display panels of the first and second sizes, and includes a bezel to cover the gap between the view area of the plasma display panel and the cabinet, and as a result it is possible to provide a plasma display television manufactured with the resin molding metal molds that enables cost reduction, space saving, and high productivity.

Another aspect of present invention provides resin molding metal molds for molding a cabinet to be mounted to the view area of a flat panel display, wherein: the flat display panel has at least two different sizes; the metal molds comprise a core metal mold and a cavity metal mold; the core metal mold is a common metal mold having a concave portion that forms a resin molding cavity corresponding to all sizes of the cabinet for flat display panels, while the cavity metal mold is a metal mold that has a convex portion forming a resin molding cavity corresponding to each size of the cabinet for a flat display panel, and that has the number of metal molds corresponding to the number of sizes of the cabinet; and one of the cavity metal molds is combined with the single common core metal mold according to the size of the flat display panel, and when the both metal molds are relatively contacted, part of the concave portion is covered by the convex portion according to the size, and resin is injected into a cavity formed by the concave portion and the convex portion to mold the cabinet according to the size of a flat display panel.

In this aspect as described above, different -sized flat display panel cabinets are molded by combining one common core metal mold with an appropriate cavity metal mold according to the size of the cabinet, and when both metal molds are contacted, part of the concave portion is covered by the convex portion according to the size, and resin is injected into a cavity formed by the concave portion and the convex portion.

Accordingly, the number of metal molds can be reduced by using a common core metal mold for different sized cabinet, and also the double structure becomes unnecessary that is required when mounting the common cabinet to different-sized flat panel displays and includes a bezel to cover the gap between the view area of the flat panel display and the cabinet, and thus it is possible to provide resin molding metal molds that enables cost reduction, space saving, and high productivity.

An optional aspect of the present invention provides resin molding metal molds, wherein: said concave portion of said core metal mold has a plurality of approximately rectangular molding grooves according to the number of sizes, at positions corresponding to the view area circumference of the flat display, and said each molding groove is composed of a bottom surface corresponding to a position opposite the screen of the flat display panel and both side surfaces thereof, and a side surface formed around the undersurface; said convex portion of said each cavity metal mold corresponding to each size of said flat display panel is composed of an approximately rectangular undersurface having the same shape as an approximate rectangle surrounded by each molding groove corresponding to said each size of the flat display panel, and a side surface formed around the undersurface; to mold a cabinet, said common core metal mold is combined with said cavity metal mold according to the size of said flat display panel, contacting said approximately rectangular bottom surface of said core metal mold and an undersurface of said convex portion of said cavity metal mold, covering part of said concave portion by said convex portion according to the size of said flat display panel, and injecting resin into a cavity formed by a peripheral area of the bottom surface of said core metal mold not contacting the undersurface of said convex portion of said cavity metal mold, the side, and a side of said convex portion on said cavity metal mold; the number of metal molds is reduced by using a common core metal mold for different-sized flat panel displays; and at the same time, the double structure is made unnecessary which is required when mounting a common cabinet to different-sized plasma display panels and which includes a bezel to cover the gap between the view area of said plasma display panel and said cabinet.

In this aspect as described above, different -sized flat display panel cabinet is molded by combining a common core metal mold with a cavity metal mold according to the size, and injecting resin into a cavity formed by a molding groove on the core metal mold not covered by the undersurface of the convex portion on the cavity metal mold and the surface of the convex portion.

Accordingly, the number of metal molds can be reduced by using a common core metal mold for different sized cabinet, and also the double structure becomes unnecessary that is required when mounting the common cabinet to different-sized flat panel displays and includes a bezel to cover the gap between the view area of the flat panel display and the cabinet, and thus it is possible to provide resin molding metal molds that enables cost reduction, space saving, and high productivity.

Another optional aspect of the present aspect provides resin molding metal molds, wherein: a concave portion of said core metal mold is composed of an approximately rectangular bottom surface surrounding an area corresponding to the largest-sized view area circumference of a flat display panel and the outward thereof by cabinet thickness, and a side surface formed around the bottom surface; a convex portion of said each cavity metal mold corresponding to each size of the flat display panel is composed of an approximately rectangular undersurface surrounding an area corresponding to the view area circumference of said each sized flat panel display, and a side surface formed around the undersurface; to mold a cabinet, said one common core metal mold is combined with said cavity metal mold as appropriate according to the size of the flat display panel, said approximately rectangular bottom surface of said core metal mold and a undersurface of said convex portion of said cavity metal mold are contacted with each other, part of said concave portion is covered by said convex portion according to the size, and resin is injected into a cavity formed by a peripheral area of the undersurface of the convex portion of the cavity metal mold not contacting the undersurface, the side surface, and the side surface of said convex portion of the cavity metal mold; the number of metal molds is reduced by using a common core metal mold for different-sized flat display panels; and the double structure is made unnecessary which is required when mounting a common cabinet to different-sized general-purpose plasma display panels and which includes a bezel to cover the gap between the view area of said plasma display panel and said cabinet.

In this aspect as described above, a cabinet for different-sized flat display panels is molded by combining a common core metal mold with an appropriate cavity metal mold according to the size of the flat display panel, and when both metal molds are contacted, part of the concave portion is covered by the convex portion according to the size, and resin is injected into a cavity formed by the peripheral area of the bottom surface of the core metal mold not contacting the undersurface of the convex portion on the cavity metal mold, the side, and a side of the convex portion on the cavity metal mold.

Accordingly, the number of metal molds can be reduced by using a common core metal mold for different sized cabinet, and also the double structure becomes unnecessary that is required when mounting the common cabinet to different-sized flat panel displays and includes a bezel to cover the gap between the view area of the flat panel display and the cabinet, and thus it is possible to provide resin molding metal molds that enables cost reduction, space saving, and high productivity.

Another optional aspect of the present invention provides resin molding metal molds wherein: the flat display panel is a 26-inch or 27-inch general-purpose plasma display panel; the core metal mold has two different molding grooves: an approximately rectangular first molding groove located at a position corresponding to a first view area circumference of a 26-inch plasma display panel, and an approximately rectangular second molding groove that is one size larger than the first view area circumference and located at a position corresponding to a second view area circumference of a 27-inch plasma display panel; the first molding groove and the second molding groove are formed on an area with approximately trapezoidal cross-section composed of a bottom surface corresponding to a position opposite to the screen of a plasma display panel, an approximately vertical surface corresponding to the inward side of the view area, and an expanding tapered surface corresponding to outward side of the view area; the cavity metal mold includes a first cavity metal mold for a 26-inch plasma display panel, and a second cavity metal mold for a 27-inch plasma display panel; the cavity metal mold has a convex portion with approximately trapezoidal cross-section which is composed of an undersurface having the same shape as an approximate rectangle surrounded by the first molding groove of the core metal mold, and an upwardly expanding tapered surface formed around the undersurface; the first cavity metal mold has a convex portion with approximately trapezoidal cross-section that is composed of an undersurface having the same shape as an approximate rectangle surrounded by the first molding groove of the core metal mold; the second cavity metal mold has a convex portion with approximately trapezoidal cross-section which is composed of an undersurface having the same shape as an approximate rectangle surrounded by the second molding groove of the core metal mold, and an upwardly expanding tapered surface formed around the undersurface; a cabinet for a 26-inch plasma display panel is molded by contacting an approximately rectangular surface surrounded by the first molding groove on the core metal mold and a undersurface of the convex portion on the first cavity metal mold, and injecting resin into a cavity formed by the first molding groove and the second molding groove of the core metal mold, a surface between these two molding grooves, an outward surface of the second molding groove, the tapered surface of the convex portion on the first cavity metal mold, and an outward upper surface thereof;

a cabinet for the 27-inch plasma display panel is molded by contacting an approximately rectangular surface surrounded by the second molding groove of the core metal mold and an undersurface of the convex portion of the second cavity metal mold, covering the first molding groove by the undersurface of the convex portion, and injecting resin into a cavity formed by the second molding groove of the core metal mold and a surface outward thereof, and a tapered surface of the convex portion on the second cavity metal mold and an upward upper surface thereof; one of the two cavity metal molds is combined with a common core metal mold as appropriate, and cabinets for 26-inch and 27-inch general-purpose plasma display panels respectively are individually molded; the number of metal mold can be reduced by using a common core metal mold for 26-inch and 27-inch general-purpose plasma display panels; and the need for the double structure is eliminated that is required to cover the gap between the view area of the plasma display panel and the cabinet when mounting a 26-inch or 27-inch general-purpose plasma display to a common cabinet.

In this aspect as described above, a cabinet for a 26-inch plasma display panel is molded by using a combination of the core metal mold and the first cavity metal mold and injecting resin into a cavity formed by the first and second molding grooves on the core metal, a surface between these molding grooves, a surface outward of the second molding groove, while the tapered surface and outward upper surface of the convex portion on the first cavity metal mold, and a cabinet for a 27-inch plasma display panel is molded by injecting resin into a cavity formed by the second molding groove on the core metal mold and an outward surface thereof and the tapered surface and an outward upper surface of the convex portion of the second cavity meta mold, with the first molding groove being covered by the bottom surface of the convex portion.

Accordingly, the number of metal molds can be reduced by using a common core metal mold for 26-inch and 27-inch plasma display panels, and also the double structure becomes unnecessary that is required when mounting a common cabinet to general-purpose plasma display panels of the first and second sizes, and includes a bezel to cover the gap between the view area of the plasma display panel and the cabinet, and

Another optional aspect of the present invention provides the resin molding metal molds wherein: the flat panel display is a 26-inch or 27-inch general-purpose plasma display panel; a concave portion of the core metal mold is composed of an approximately rectangular bottom surface surrounding the view area circumference of a 27-inch plasma display panel and an area corresponding to the thickness outward of the cabinet, and an upwardly expanding tapered surface formed around the bottom surface; the cavity metal mold includes a third cavity metal mold for a 26-inch plasma display panel, and a fourth cavity metal mold for a 27-inch plasma display panel; the third cavity metal mold has a convex portion with approximately trapezoidal cross-section that is composed of an approximately rectangular undersurface surrounding an area corresponding to the view area of a 26-inch plasma display panel and an upwardly expanding tapered surface formed around the undersurface; the fourth cavity metal mold has a convex portion that is one size larger with approximately trapezoidal cross-section that is composed of an approximately rectangular undersurface surrounding an area corresponding to the view area circumference of a 27-inch plasma display panel and an upwardly expanding tapered surface formed around the undersurface; a 26-inch plasma display panel cabinet is molded by contacting an approximately rectangular bottom surface of the core metal mold and an undersurface of the concave portion of the third cavity metal mold, covering part of the concave portion by the convex portion, and injecting resin into a cavity formed by a peripheral area of the bottom surface of the concave portion of the core metal mold not contacting the undersurface of the convex portion of the cavity metal mold, the tapered surface, an outward upper surface of the concave portion, the tapered surface of the convex portion of the cavity metal mold, and an outward upper surface of the convex portion; a 27-inch plasma display panel cabinet is molded by contacting an approximately rectangular bottom surface of the core metal mold and an undersurface of the convex portion of the fourth cavity metal mold, covering part of an surface of the concave portion, which is one size larger than for a 26-inch plasma display panel, by the convex portion, and injecting resin into a cavity formed by a peripheral area of the bottom surface of the concave portion of the core metal mold not contacting the undersurface of the convex portion of the cavity metal mold, the tapered surface, an outward upper surface of the concave portion, the tapered surface of the convex portion of the cavity metal mold, and an outward upper surface of the convex portion; cabinets to be mounted to the view area of 26-inch and 27-inch general-purpose plasma display panels are individually molded by combining a common core metal mold with one of two cavity metal molds as appropriate; the number of metal molds is reduced by using one common core metal mold for 26-inch and 27-inch plasma display panels; and at the same time, the double structure is made unnecessary that is required when mounting a common cabinet to 26-inch and 27-inch general-purpose plasma display panels and includes a bezel to cover the gap between the view area of the plasma display panel and the cabinet.

In this aspect as described above, a 26-inch plasma display panel cabinet is molded by covering part of the concave portion by the convex portion when both molds contact with each other, and injecting resin into a cavity formed by a peripheral area of the bottom surface of the concave portion of the core metal mold not contacting the under surface of the convex portion of the cavity metal mold, the tapered surface, an outward upper surface of the convex portion, the tapered surface of the convex portion of the cavity metal mold, and an outward upper surface of the convex portion, while a 27-inch plasma display panel cabinet is molded by covering part of a surface of the concave portion, which is one size larger than for a 26-inch plasma display panel when, by the convex portion when both metal molds are contacted, and injecting resin into a cavity formed by a peripheral area of the bottom surface of the core metal mold not contacting the undersurface of the convex portion of the cavity metal mold, the tapered surface, an outward upper surface of the concave portion, the tapered surface of the convex portion of the cavity metal mold, and an outward upper surface of the convex portion.

Accordingly, the number of metal molds can be reduced by using a common core metal mold for 26-inch and 27-inch plasma display panels, and also the double structure becomes unnecessary that is required when mounting a common cabinet to 26-inch and 27-inch general-purpose plasma display panels, and includes a bezel to cover the gap between the view area of the plasma display panel and the cabinet, and as a result it is possible to provide a plasma display television manufactured with the resin molding metal molds that enables cost reduction, space saving, and high productivity.

Another optional aspect of present invention provides a resin molding method for a cabinet to be mounted to the view area of a flat display panel, wherein: the flat panel display has at least two different sizes; a core metal mold out of a pair of mating metal molds is a common metal mold having a concave surface that forms a cavity for resin molding accommodating all the sizes of the cabinet for a flat display panel; the other cavity metal mold out of the pair of mating metal molds is a metal mold that has surfaces of a convex portion forming a cavity for resin molding for each size of the cabinet for the flat display panel, and the same number of the cavity metal molds as the number of sizes of a flat display panel are prepared; and the single common core metal mold and one of the cavity metal molds combined according to the size of the flat display panel are used as appropriate, and when the both metal molds are contacted with each other, part of the concave portion is covered by the convex portion according to the size of the flat display panel, and resin is injected into a cavity formed by the concave portion and convex portion to mold the cabinet fit for the flat display panel.

This provides a resin molding method by which similar advantages can be obtained.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a bloc diagram to explain embodiment 1 of the present invention;

FIG. 2 is an exemplary illustration of a partial cross-section view to explain embodiment 1 of the present invention;

FIG. 3 is an exemplary illustration of a partial cross-section view to explain embodiment 1 of the present invention;

FIG. 4 is an exemplary illustration of a partial cross-section view to explain embodiment 1 of the present invention;

FIG. 5 is an exemplary illustration of a partial cross-section view to explain embodiment 1 of the present invention;

FIG. 6 is an exemplary illustration of a partial cross-section view to explain embodiment 2 of the present invention;

FIG. 7 is an exemplary illustration of a partial cross-section view to explain embodiment 2 of the present invention;

FIG. 8 is an exemplary illustration of a partial cross-section view to explain embodiment 2 of the present invention;

FIG. 9 is an exemplary illustration of a partial cross-section view to explain embodiment 2 of the present invention;

FIG. 10 is an exemplary illustration of a partial cross-section view to explain a prior art;

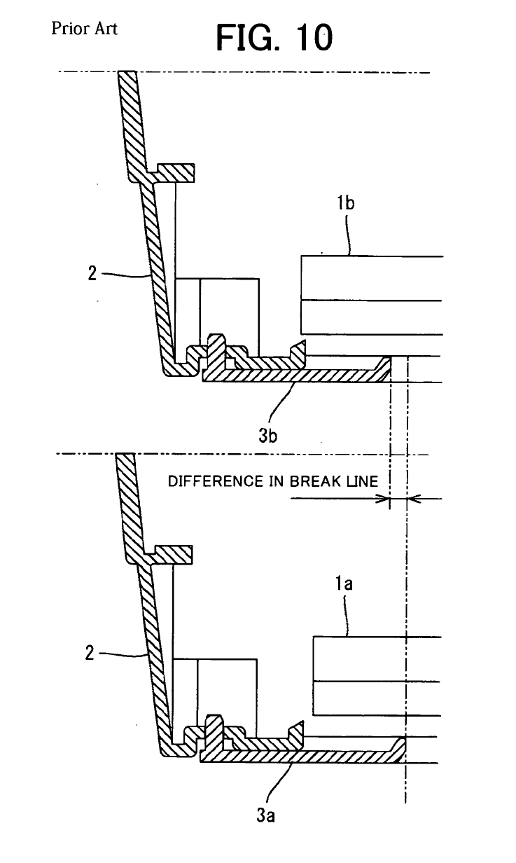

FIG. 11 is an exemplary illustration of a perspective view to explain the prior art; and

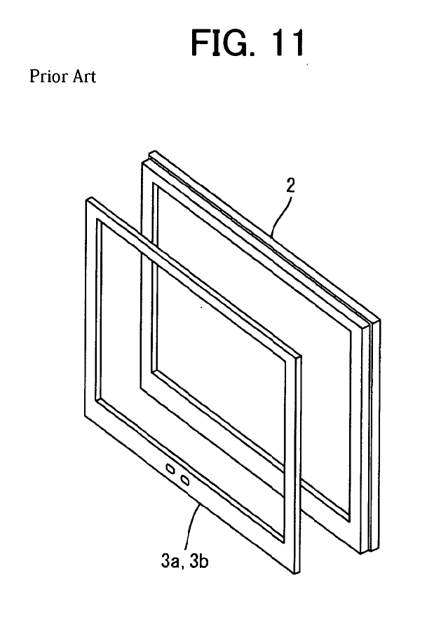

FIG. 12 is an exemplary illustration of a partial cross-section view to explain the prior art.

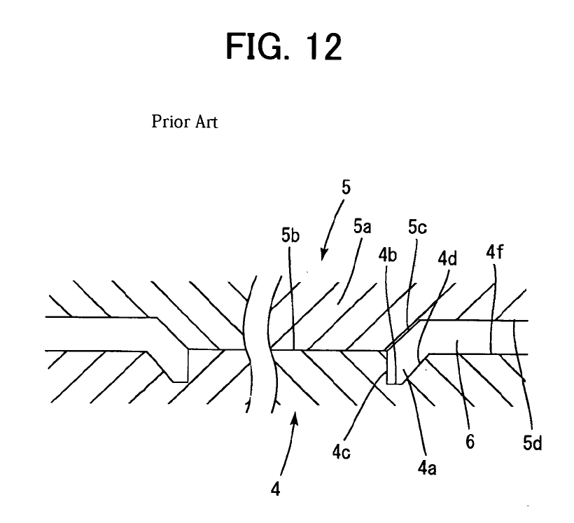

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

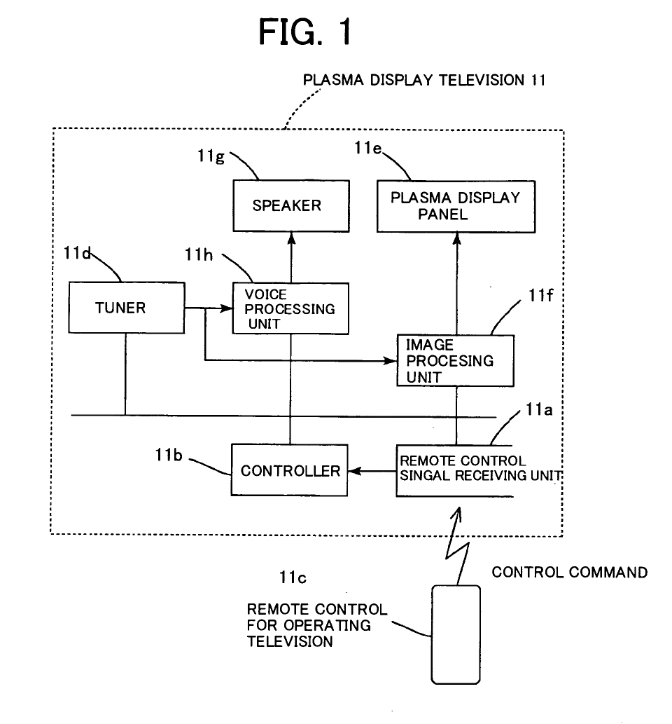

FIG. 1 shows a bloc diagram to explain a basic configuration of a plasma display television using a plasma display panel as a flat display panel of the present invention.

As illustrated in FIG. 1, a plasma display television 11 includes a controller 11b to control the operation of the plasma display television. Further included with the plasma display television 11 is a tuner 11d that extracts a television broadcast signal for a selected channel from television broadcast signals received by an antenna (not shown), and outputs the extracted signal. An image processing unit 11f displays on a plasma display panel 11e images based on the television broadcast signal outputted from the tuner 11d. An audio processing unit 11h outputs from a speaker 11g audio based on the television broadcast signals outputted from the tuner 11d. A remote control signal receiving unit 11a receives a control command transmitted from a remote control 11c.

The controller 11b controls the ON/OFF power of the system, changing of channels, audio control for volume, and similar controls according to a control command received by the remote control signal receiving unit 11a. To each unit, such as the remote control signal receiving unit 11a, the controller 11b, the tuner 11d, the plasma display panel 11e, the image processing unit 11f, and the voice processing unit 11h, in the plasma display television 11, an operating current is supplied from a power supply circuit (not shown). The input to this power supply circuit is a commercial power source (for example, 100V AC).

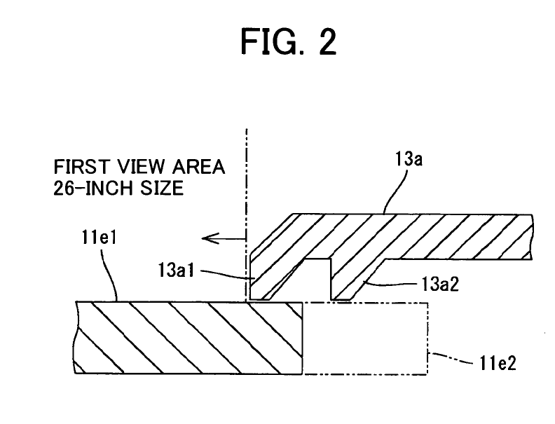

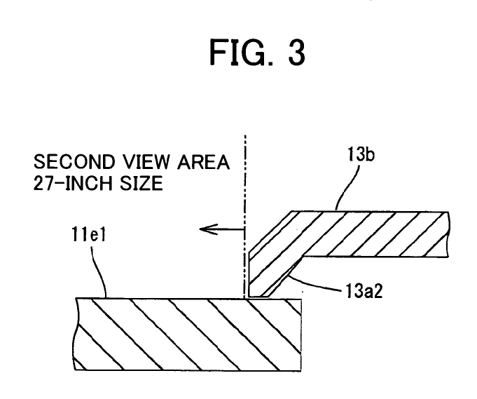

The plasma display panels 11e are supplied from a panel manufacturer as a 26-inch or 27-inch general purpose plasma display panel assemblies 11e1, and 11e1. These 26-inch and 27-inch general purpose plasma panel assemblies 11e1 and 11e2 are mounted to cabinet 13a and 13b respectively. These cabinets 13a and 13b have claw portions 13a1 and 13b1. Each claws has different shapes from each other so as to fit the different-sized view area, as shown in FIGS. 2 and 3. Accordingly no gap is formed between plasma display panel and cabinet, so there is no need of adoption the conventional double structure including a bazel.

A method of molding the cabinets 13a and 13b is described below.

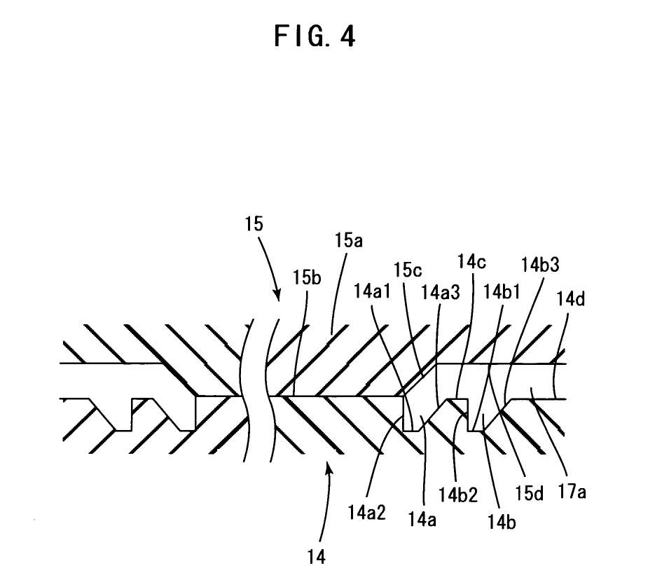

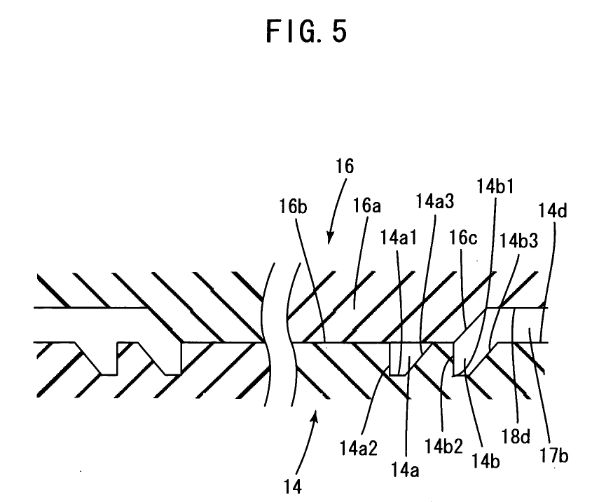

The cabinet 13a and 13b are molded with metal molds configured as shown in FIG. 4 and 5, respectively That is, a metal mold for molding the cabinet 13a for the 26-inch plasma display panel 11e1 is composed of a core metal mold 14 and a cavity metal mold 15. The core metal mold 14 has two different molding grooves, with a first approximately rectangular molding groove 14a formed at a position corresponding to first view area circumference of the 26-inch sized (first size) plasma display panel 11e1. A second approximately rectangular molding groove 14b is formed at a position corresponding to a second view area circumference, which is one size larger than the first view area circumference, of the 27-inch sized plasma display panel 11e2.

The first molding groove 14a and the second molding groove 14b are formed on an area with approximately trapezoidal cross-section that is formed by the bottom surfaces 14a1, 14b1 corresponding to the areas opposite to the screen of a plasma display panel, and approximately vertical surfaces 14a2, 14b2 corresponding to the inward of the view area; and expanding tapered surfaces 14a3, 14b3 corresponding to the outward of the view area.

The first cavity metal mold 15 has a convex portion 15a with approximately trapezoidal cross-section that is composed of an undersurface 15b of the same shape as an approximate rectangle surrounded by the first molding groove 14a on the core metal mold 14 and an upward expanding tapered surface 15c formed around the undersurface 15b.

On the other hand, the metal mold for molding the cabinet 13b for the 27-inch plasma display panel 11e2 is composed of a core metal mold 14 and second cavity metal mold 16. That is, the core metal mold 14 is shared between the 26-inch and 27-inch plasma display panels. The second cavity metal mold 16 has a convex portion 16a with approximately trapezoidal cross-section that is composed of an undersurface 16b of the same shape as an approximate rectangle surrounded by the second molding groove 14b on the core metal mold 14 and an upward expanding tapered surface 16c formed around the undersurface 16b.

To mold the cabinet 13a for the 26-inch plasma display panel 11e1, the approximately rectangular surface surrounded by the first molding groove 14a on the core metal mold 14 and the undersurface 15b of the convex portion 15a on the first cavity metal mold 15 are contacted with each other. As a result, a cavity is formed by the first molding groove 14a on the core metal mold, the second molding groove 14b, the surface 14c between these two grooves, the outward surface 14d of the second molding groove 14b, and the tapered surface 15c of the convex portion 15a on the first cavity metal mold and outward upper surface 15dthereof. By injecting resin into this cavity 17a, the cabinet 13a for the 26-inch plasma display panel 11e1 is molded.

The cabinet 13a molded as described above has the two claw portions 13a1 and 13a2 corresponding to the first molding groove 14a and second molding groove 14b, respectively, as shown in FIG. 2. The claw portion 13a1 located on the edge faces the view area circumference of the 26-inch plasma display panel 11e1 when mounted. The conventional double structure, including a bezel is not necessary and the required peripheral positions on the plasma display panel 11e1 are completely covered with only the cabinet 13a. The other claw portion 13a2 is located opposite to the view area circumference of the 27-inch plasma display panel described later, and is not necessary for mounting the 26-inch plasma display panel 11e1, but has no problem since claw portion 13a2 is located within the cabinet 13a, hidden from view.

To mold the cabinet 13b for the 27-inch plasma display panel, the approximately rectangular surface surrounded by the second molding groove 14b on the core metal mold 14 and the undersurface 16b of the convex portion 16a on the second cavity metal mold 16 are contacted with each other. As a result, the first molding groove 14a is covered at the underside of the convex portion 16a, and a cavity 17b is formed by the second molding 14b and the outward surface 14d thereof, and the tapered surface 16c of the convex portion on the second cavity metal mold 16 and the outward surface 16d thereof. By injecting resin into this cavity 17b, the cabinet 13b for the 27-inch plasma display panel 11e2 is molded.

The cabinet 13b molded as described above has no claw portion 13a1 for the 26-inch plasma display panel as shown in FIG. 3, since the first molding groove 14a on the core metal mold 14 is covered at the undersurface of the convex portion on the second cavity metal mold 16 and resin will not flow therein, resulting in only the claw portion 13a2 corresponding to the second molding groove 14b being formed. The claw portion 13a2 located on the edge faces the view area circumference of the 27-inch plasma display panel 11e2 when mounted. The conventional double structure, including a bezel is not necessary and the required peripheral positions on the plasma display panel 11e2 are completely covered with only the cabinet 13b.

As described above, in this embodiment, the cabinets 13a and 13b to be mounted on the view area of the 26-inch and 27-inch general-purpose plasma display panels can be molded individually. This can be achieved by combining, as appropriate, the core metal mold 14 and one of the two different cavity metal molds 15 and 16, which correspond to the 26-inch and 27-inch plasma display panels, and covering the unnecessary first molding groove on the core metal mold 14 by the cavity metal mold 14 when molding the 27-inch cabinet 13b.

Accordingly, by sharing one core metal mold 14 in molding the different sized (26-inch and 27-inch) cabinets, the number of metal molds is reduced as compared with the prior art, and also the conventional double structure becomes unnecessary that includes a bezel to cover the gap between the view area of a plasma display panel and the cabinet, which is required to mount the common cabinet for 26-inch and 27-inch general-purpose plasma display panels. As a result, it is possible to provide metal molds for resin molding that achieves cost saving, space saving, and improved productivity.

Next, another embodiment is described that is substantially similar as the above-mentioned embodiment in that one core metal mold and one of two different cavity metal molds corresponding to 26-inch and 27-inch plasma display panels are combined as appropriate, and cabinets to be mounted to the view area sides of the two different-sized general-purpose plasma displays are individually molded, but the shapes of the core metal mold and cavity metal mold are different.

Only the different configuration from the previous embodiment is described, the description of the common configuration being omitted.

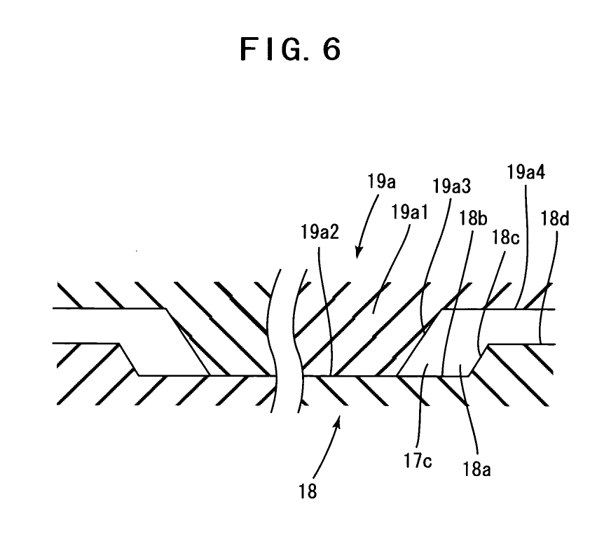

As shown in FIG. 6, a concave portion 18a on a core metal mold 18 is composed of an approximately rectangular bottom surface 18b surrounding an area corresponding to the view area circumference of the 27-inch plasma display panel 11e2 and the outward thick portion of the cabinet, and a upward tapered surface 18c formed around the bottom surface 18b.

On the other hand, the cavity metal mold includes a third cavity metal mold 19a corresponding to the 26-inch plasma display panel 11e1, and a fourth cavity metal mold 19b corresponding to the 27-inch plasma display panel 11e2.

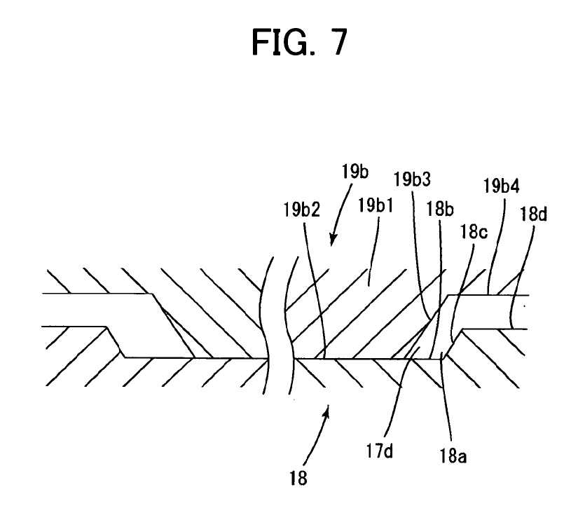

The third cavity metal mold 19a has a convex portion 19a1 with approximately trapezoidal cross-section that is composed of an approximately rectangular undersurface 19a2 surrounding an area corresponding to the view area of the 26-inch plasma display panel 11e1 and an upward tapered surface 19a3 formed around the undersurface 19a2, while, in FIG. 7, the fourth cavity metal mold 19b has a convex portion 19b1 that is one size larger with approximately trapezoidal cross-section that is composed of an approximately rectangular undersurface 19b2 surrounding an area corresponding to the view area of the 27-inch plasma display panel 11e2 and a upward expanding tapered surface 19b3 formed around the undersurface 19b2.

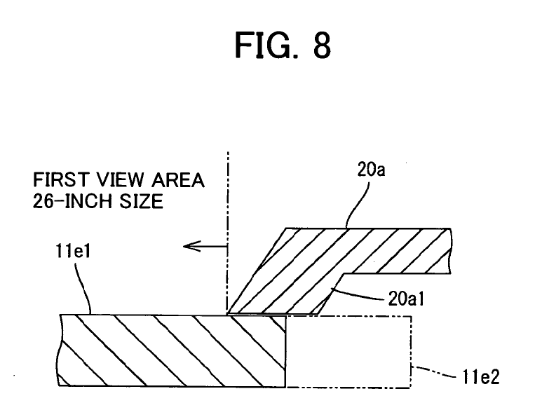

As shown in FIG. 6, to mold the cabinet for a 26-inch plasma display panel, the approximately rectangular bottom surface 18b on the core metal mold 18 and the undersurface 19a2 of the convex portion 19a1 on the third cavity metal mold 19a are contacted with each other. As a result, a part of the concave portion 18a is covered by the convex portion 19b, and a cavity 17c is formed by: a peripheral area of the bottom surface 18b, which does not contact the undersurface 19a2; the tapered surface 18c; an outward upper surface 18d of the concave portion 18a; the tapered surface 19a3; and an outward upper surface 19a4. By injecting resin into this cavity 17c, the cabinet for a 26-inch plasma display panel as shown in FIG. 8 is molded.

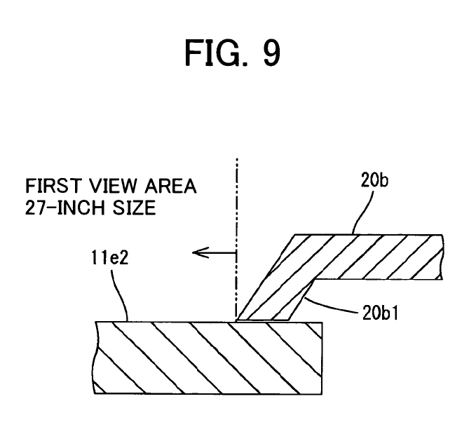

The cabinet 20a molded as described above has a claw portion 20a1. When the cabinet 20a is mounted the claw portion 20a1 is located at a position opposite to the view area circumference of the 26-inch plasma display panel 11e1, and the required peripheral positions of the plasma display panel 11e1 are completely covered by only the cabinet 20a, without the need of adopting the conventional double structure with a bezel. Since the peripheral side tapered surface of the claw portion 20a1 is located at the same position of the claw portion 20b1 (illustrated in FIG. 9) corresponding to the view area circumference of the 27-inch plasma display panel, claw portion 20a1 is thicker than the claw portion 20b1, but it has no problem since it is located within the cabinet 20a hidden from the eye, and therefore.

On the other hand, to mold the cabinet 20b (illustrated in FIG. 9) for a 27-inch plasma display panel, as shown in FIG. 7, the approximately rectangular bottom surface 18b on the core metal mold and the undersurface 19bs of the convex portion 19ba on the fourth cavity metal mold 19b are contacted with each other,. As a result, part of an area of the concave portion 18a is covered by the convex portion 19b1, and the covered area of the concave portion 18a is one size larger of the concave portion than in the case of the 26-inch plasma display panel. A cavity 17d is formed by: a peripheral area of bottom surface 18b, which does not contact the undersurface 19b2; the tapered surface 18c; the outward upper surface 18d of the concave portion; the tapered surface 19b3; and the outward upper surface 19b4. By injecting resin into this cavity, the cabinet 20b for a 27-inch plasma display panel as shown in Fir 9 is formed.

The cabinet 20b molded as described above has a claw portion 20b1, as illustrated in FIG. 9. When the cabinet 20b is mounted, the claw portion 20b1 is located at an area opposite to the view area circumference of the plasma display panel 11e2, and the required peripheral positions of the plasma display panel 11e2 is completely covered by only the cabinet 20b, without the need of adopting the conventional double structure with a bezel.

As described above, this embodiment is different from the first embodiment in that the size difference between 26-inch and 27-inch plasma display panels is accommodated by changing the size of an area where part of the concave portion is covered by the convex portion, thereby changing the thickness of the claw portion of the cabinet. However, both embodiments are substantially similar in that two different cavity metal molds corresponding to the sizes of 26-inch and 27-inch plasma display panels are prepared. The two different cavity metal molds are used by combining one of these metal molds with one core metal mold as appropriate. When the core and cavity metal molds are contacted with each other, part of the concave portion is covered by the convex portion according to the size of a plasma display panel. Resin is injected into a cavity formed by the concave portion and the convex portion to mold the cabinet to be mounted to the view area of a 26-inch or 27-inch general-purpose plasma display.

Accordingly, this embodiment uses the same core metal mold for two different-sized (26-inch and 27-inch) plasma display panels. This reduces the number of metal mold as compared with the prior art, and eliminates the need for the conventional double structure wherein a bezel is mounted to cover the gap between view area of the plasma display panel and the cabinet, which is required for a common cabinet to different-sized (26-inch and 27-inch) general-purpose plasma display panels. Consequently, it is possible to provide metal molds for resin molding whereby cost reduction, space saving, and productivity improvement can be achieved.

The present invention is not limited to the configuration of each embodiment, and can be modified to apply to the following non-limiting exemplary configurations listed below.

1. In each embodiment, a plasma display panel is described as an example of the flat display panel, but the present invention is not limited thereto and applicable to other flat display panels including an LCD and an organic EL.

b 2. In each embodiment, the vertical cross-section or horizontal cross-section of the concave portion and the convex portion (i.e., the cabinet to be molded) on the core metal mold and the cavity metal mold is only an example and can be changed as appropriate. The point is that it is sufficient to be able to form a cavity whereby a cabinet can be molded that fits the size of a flat display panel to which the cabinet is mounted.

3. Although the panel sizes used in the embodiments are 26-inch and 27-inch, these sizes are only examples and other sizes are possible. However, sizes must be adjacent to each other, such as a case that sizes are consecutive in a sequence, so that a common cabinet can be used.

4. Panel sizes that allow molding with a common core metal mold are not limited to two sizes, and three or more sizes are possible. In such a case, a concave portion must be formed according to each additional size.

5. Although each embodiment is configured to eliminate the double structure with a bezel, it is possible to leave this double structure with a bezel and use a common cabinet to apply the molding with each metal mold to a different bezel according to the size of a display panel. This eliminates the advantage of making the double structure with a bezel unnecessary, but at least the conventional advantage of reducing the number of metal molds in bezel molding can be obtained.

6. The configuration described in each embodiment can be provided as not only a plasma television and metal molds for resin molding but also a resin molding method.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A plasma display television whose cabinet molded by resin molding metal molds is mounted to the view area of a plasma display panel as a flat display panel, wherein:
the plasma display panel is a general-purpose plasma display panel of one of a first size or a second size that is slightly larger than the first size;
the metal molds include a core metal mold and cavity metal mold used in pairs;
the core metal mold has two different molding grooves: an approximately rectangular first molding groove located at a position corresponding to a first view area circumference of the plasma display panel of the first size, and an approximately rectangular second molding groove that is one size larger than the first view area circumference and located at a position corresponding to a second view area circumference of the plasma display panel of the second size;
the first molding groove and the second molding groove are formed on an area with approximately trapezoidal cross-section composed of a bottom surface corresponding to a position opposite to the screen of a plasma display panel, an approximately vertical surface corresponding to an inward side of the view area, and an expanding tapered surface corresponding to an outward side of the view area;
the cavity metal mold has two different cavity metal molds including a first cavity metal mold corresponding to a first size of the plasma display panel, and a second cavity metal mold corresponding to a second size of the plasma display panel;
the fist cavity metal mold has a convex portion with approximately trapezoidal cross-section which is made up of an undersurface having the same shape as an approximate rectangle surrounded by the first molding groove on the core metal mold, and an upwardly expanding tapered surface formed around the undersurface;
the second cavity metal mold has a convex portion with approximately trapezoidal cross-section which is made up of an undersurface having the same shape as an approximate rectangle surrounded by the second molding groove on the core metal mold, and an upwardly expanding tapered surface formed around the undersurface;
a cabinet for a plasma display panel of the first size is molded by making an approximately rectangular surface surrounded by the first molding groove on the core metal mold and an undersurface of the convex portion on the first cavity metal mold relatively contact each other, and injecting resin into a cavity formed by the first molding groove and the second molding groove on the core metal mold, a surface between these two molding grooves, an outward surface of the second molding groove, a tapered surface of the convex portion on the first cavity metal mold, and an outward upper surface thereof;
a cabinet for the plasma display panel of the second size is molded by contacting an approximately rectangular surface surrounded by the second molding groove on the core metal mold and an undersurface of the convex portion on the second cavity metal mold, covering the first molding groove by an undersurface of the convex portion, and injecting resin into a cavity formed by the second molding groove on the core metal mold and a surface outward thereof, and a tapered surface of the convex portion of the second cavity metal mold and an upward upper surface thereof;
one of the two cavity metal molds is combined with a common core metal mold as appropriate, and cabinets for two general-purpose plasma display panels of the first and seconds sizes respectively are individually molded;
the number of metal mold can be reduced by using a common core metal mold for general-purpose plasma display panels of the first and second sizes; and
the need for the double structure is eliminated that is required to cover the gap between the view area of the plasma display panel and the cabinet when mounting a general-purpose plasma display of the first size or the second sizes to a common cabinet.

2. Resin molding metal molds for molding a cabinet to be mounted to the view area of a flat panel display, wherein:
the flat display panel has at least two different sizes;
the metal molds comprise a core metal mold and a cavity metal mold;
the core metal mold is a common metal mold having a concave portion that forms a resin molding cavity corresponding to all sizes of the cabinet for flat display panels,
while the cavity metal mold is a metal mold that has a convex portion forming a resin molding cavity corresponding to each size of the cabinet for a flat display panel, and that has the number of metal molds corresponding to the number of sizes of the cabinet; and
one of the cavity metal molds is combined with the single common core metal mold according to the size of the flat display panel, and when the both metal molds are relatively contacted, part of the concave portion is covered by the convex portion according to the size, and resin is injected into a cavity formed by the concave portion and the convex portion to mold the cabinet according to the size of a flat display panel.

3. The resin molding metal molds as defined in claim 2, wherein:
said concave portion of said core metal mold has a plurality of approximately rectangular molding grooves according to the number of sizes, at positions corresponding to the view area circumference of the flat display, and said each molding groove is composed of a bottom surface corresponding to a position opposite the screen of the flat display panel and both side surfaces thereof, and a side surface formed around the undersurface;
said convex portion of said each cavity metal mold corresponding to each size of said flat display panel is composed of an approximately rectangular undersurface having the same shape as an approximate rectangle surrounded by each molding groove corresponding to said each size of the flat display panel, and a side surface formed around the undersurface;
to mold a cabinet, said common core metal mold is combined with said cavity metal mold according to the size of said flat display panel, contacting said approximately rectangular bottom surface of said core metal mold and an undersurface of said convex portion of said cavity metal mold, covering part of said concave portion by said convex portion according to the size of said flat display panel, and injecting resin into a cavity formed by a peripheral area of the bottom surface of said core metal mold not contacting the undersurface of said convex portion of said cavity metal mold, the side, and a side of said convex portion on said cavity metal mold;
the number of metal molds is reduced by using a common core metal mold for different-sized flat panel displays; and at the same time, the double structure is made unnecessary which is required when mounting a common cabinet to different-sized plasma display panels and which includes a bezel to cover the gap between the view area of said plasma display panel and said cabinet.

4. The resin molding metal molds as defined in claim 2, wherein:
a concave portion of said core metal mold is composed of an approximately rectangular bottom surface surrounding an area corresponding to the largest-sized view area circumference of a flat display panel and the outward thereof by cabinet thickness, and a side surface formed around the bottom surface;
a convex portion of said each cavity metal mold corresponding to each size of the flat display panel is composed of an approximately rectangular undersurface surrounding an area corresponding to the view area circumference of said each sized flat panel display, and a side surface formed around the undersurface;
to mold a cabinet, said one common core metal mold is combined with said cavity metal mold as appropriate according to the size of the flat display panel, said approximately rectangular bottom surface of said core metal mold and a undersurface of said convex portion of said cavity metal mold are contacted with each other, part of said concave portion is covered by said convex portion according to the size, and resin is injected into a cavity formed by a peripheral area of the undersurface of the convex portion of the cavity metal mold not contacting the undersurface, the side surface, and the side surface of said convex portion of the cavity metal mold;
the number of metal molds is reduced by using a common core metal mold for different-sized flat display panels; and
the double structure is made unnecessary which is required when mounting a common cabinet to different-sized general-purpose plasma display panels and which includes a bezel to cover the gap between the view area of said plasma display panel and said cabinet.

5. The resin molding metal molds as defined in claim 3, wherein:
the flat display panel is a 26-inch or 27-inch general-purpose plasma display panel;
the core metal mold has two different molding grooves: an approximately rectangular first molding groove located at a position corresponding to a first view area circumference of a 26-inch plasma display panel, and an approximately rectangular second molding groove that is one size larger than the first view area circumference and located at a position corresponding to a second view area circumference of a 27-inch plasma display panel;
the first molding groove and the second molding groove are formed on an area with approximately trapezoidal cross-section composed of a bottom surface corresponding to a position opposite to the screen of a plasma display panel, an approximately vertical surface corresponding to the inward side of the view area, and an expanding tapered surface corresponding to outward side of the view area;
the cavity metal mold includes a first cavity metal mold for a 26-inch plasma display panel, and a second cavity metal mold for a 27-inch plasma display panel;
the cavity metal mold has a convex portion with approximately trapezoidal cross-section which is composed of an undersurface having the same shape as an approximate rectangle surrounded by the first molding groove of the core metal mold, and an upwardly expanding tapered surface formed around the undersurface;
the first cavity metal mold has a convex portion with approximately trapezoidal cross-section that is composed of an undersurface having the same shape as an approximate rectangle surrounded by the first molding groove of the core metal mold;
the second cavity metal mold has a convex portion with approximately trapezoidal cross-section which is composed of an undersurface having the same shape as an approximate rectangle surrounded by the second molding groove of the core metal mold, and an upwardly expanding tapered surface formed around the undersurface;
a cabinet for a 26-inch plasma display panel is molded by contacting an approximately rectangular surface surrounded by the first molding groove on the core metal mold and a undersurface of the convex portion on the first cavity metal mold, and injecting resin into a cavity formed by the first molding groove and the second molding groove of the core metal mold, a surface between these two molding grooves, an outward surface of the second molding groove, the tapered surface of the convex portion on the first cavity metal mold, and an outward upper surface thereof;
a cabinet for the 27-inch plasma display panel is molded by contacting an approximately rectangular surface surrounded by the second molding groove of the core metal mold and an undersurface of the convex portion of the second cavity metal mold, covering the first molding groove by the undersurface of the convex portion, and injecting resin into a cavity formed by the second molding groove of the core metal mold and a surface outward thereof, and a tapered surface of the convex portion on the second cavity metal mold and an upward upper surface thereof;
one of the two cavity metal molds is combined with a common core metal mold as appropriate, and cabinets for 26-inch and 27-inch general-purpose plasma display panels respectively are individually molded;
the number of metal mold can be reduced by using a common core metal mold for 26-inch and 27-inch general-purpose plasma display panels; and
the need for the double structure is eliminated that is required to cover the gap between the view area of the plasma display panel and the cabinet when mounting a 26-inch or 27-inch general-purpose plasma display to a common cabinet.

6. The resin molding metal molds as defined in claim 4, wherein:
the flat panel display is a 26-inch or 27-inch general-purpose plasma display panel;
a concave portion of the core metal mold is composed of an approximately rectangular bottom surface surrounding the view area circumference of a 27-inch plasma display panel and an area corresponding to the thickness outward of the cabinet, and an upwardly expanding tapered surface formed around the bottom surface;
the cavity metal mold includes a third cavity metal mold for a 26-inch plasma display panel, and a fourth cavity metal mold for a 27-inch plasma display panel;
the third cavity metal mold has a convex portion with approximately trapezoidal cross-section that is composed of an approximately rectangular undersurface surrounding an area corresponding to the view area of a 26-inch plasma display panel and an upwardly expanding tapered surface formed around the undersurface;
the fourth cavity metal mold has a convex portion that is one size larger with approximately trapezoidal cross-section that is composed of an approximately rectangular undersurface surrounding an area corresponding to the view area circumference of a 27-inch plasma display panel and an upwardly expanding tapered surface formed around the undersurface;
a 26-inch plasma display panel cabinet is molded by contacting an approximately rectangular bottom surface of the core metal mold and an undersurface of the concave portion of the third cavity metal mold, covering part of the concave portion by the convex portion, and injecting resin into a cavity formed by a peripheral area of the bottom surface of the concave portion of the core metal mold not contacting the undersurface of the convex portion of the cavity metal mold, the tapered surface, an outward upper surface of the concave portion, the tapered surface of the convex portion of the cavity metal mold, and an outward upper surface of the convex portion;
a 27-inch plasma display panel cabinet is molded by contacting an approximately rectangular bottom surface of the core metal mold and an undersurface of the convex portion of the fourth cavity metal mold, covering part of an surface of the concave portion, which is one size larger than for a 26-inch plasma display panel, by the convex portion, and injecting resin into a cavity formed by a peripheral area of the bottom surface of the concave portion of the core metal mold not contacting the undersurface of the convex portion of the cavity metal mold, the tapered surface, an outward upper surface of the concave portion, the tapered surface of the convex portion of the cavity metal mold, and an outward upper surface of the convex portion;
cabinets to be mounted to the view area of 26-inch and 27-inch general-purpose plasma display panels are individually molded by combining a common core metal mold with one of two cavity metal molds as appropriate;
the number of metal molds is reduced by using one common core metal mold for 26-inch and 27-inch plasma display panels; and
at the same time, the double structure is made unnecessary that is required when mounting a common cabinet to 26-inch and 27-inch general-purpose plasma display panels and includes a bezel to cover the gap between the view area of the plasma display panel and the cabinet.

7. A resin molding method for a cabinet to be mounted to the view area of a flat display panel, wherein:
the flat panel display has at least two different sizes;
a core metal mold out of a pair of mating metal molds is a common metal mold having a concave surface that forms a cavity for resin molding accommodating all the sizes of the cabinet for a flat display panel;
the other cavity metal mold out of the pair of mating metal molds is a metal mold that has surfaces of a convex portion forming a cavity for resin molding for each size of the cabinet for the flat display panel, and the same number of the cavity metal molds as the number of sizes of a flat display panel are prepared; and
the single common core metal mold and one of the cavity metal molds combined according to the size of the flat display panel are used as appropriate, and when the both metal molds are contacted with each other, part of the concave portion is covered by the convex portion according to the size of the flat display panel, and resin is injected into a cavity formed by the concave portion and convex portion to mold the cabinet fit for the flat display panel.
